(19) United States
(12) Patent Application Publication
(10) Pub. No.: US 2013/0273807 A1
(43) Pub. Date: Oct. 17, 2013

(54) STRUCTURE AND CONFIGURATION FOR TOP BAR HIVE

(71) Applicant: AUNT BEA'S BACKYARD BEEHIVES, LLC, FALLS CHURCH, VA (US)

(72) Inventor: John PETRO, Falls Church, VA (US)

(73) Assignee: AUNT BEA'S BACKYARD BEEHIVES, LLC, FALLS CHURCH, VA (US)

(21) Appl. No.: 13/864,555

(22) Filed: Apr. 17, 2013

Related U.S. Application Data
(60) Provisional application No. 61/625,303, filed on Apr. 17, 2012.

(51) Int. Cl. A01K 53/00; A01K 47/06

(52) U.S. Cl. CPC A01K 53/00; A01K 47/06
USPC 449/11; 449/3

(57) ABSTRACT

A hive for feeding bees includes features to provide multiple configurations based on the needs of the bees. The hive includes side ports that use glass plates and port covers to allow access to the interior of the hive without unnecessarily disturbing the bees. The hive also uses a top bar configuration to promote bee health and productivity. The hive also includes hive ends to receive feeding assemblies that provide materials to the bees without disturbing the interior of the hive.

### FIELD OF THE INVENTION

The present invention relates to hives for bees. More particularly, the present invention relates to an improved structure for a top bar hive that facilitates significant, sustainable and improved hive operational and management options for a beekeeper and the bees.

### DISCUSSION OF THE RELATED ART

Conventional beehives may separate into two major categories: movable frame and top bar. Within the movable frame category, a typical hive may include those with a vertical, stacked-box appearance, such as the Langstroth used by commercial/industrial beekeepers. A second major category is the top bar, which has no frames and the honey-filled comb is not returned to the hive after being harvested.

Top bar hives, may separate into two sub-categories: horizontal and vertical. A growing number of amateur beekeepers adopt various top bar hives similar to the horizontal Tanzanian and Kenyan hives found in Africa. In the 1960's, a USAID program to promote beekeeping in Kenya introduced a hive utilizing ancient Greek top bar principles, calling it Kenya Top Bar Hive (“KTBH”). Based upon the success of the KTBH in Africa, beekeepers in the US and Europe, both experienced and novice began to experiment with the design as an improvement for their purposes of sustainable beekeeping. The KTBH encourages and facilitates a more natural, sustainable, chemical-free approach and is more about conservation than big honey harvests. Interference in the natural lives of the bees is kept to a minimum using the KTBH configuration.

The KTBH is a well-known horizontal top bar hive. A well-known vertical top bar hive is the Warre that is similar to the stacked boxes of a Langstroth hive, except that it utilizes top bars instead of frames in stacked boxes.

This natural beekeeping model utilizing the KTBH offers a viable alternative to the standard industrial-commercial farm model which utilizes the familiar “Langstroth” stacked-box hive. With the Langstroth hive, the goal is to produce unnaturally large quantities of honey which involves managing and controlling all aspects of the bee colony by utilizing complex and costly equipment, chemicals and processes to maximize and harvest the colony's honey, propolis and pollen. Many believe that Langstroth hives are a major reason for the decline of the honeybee population. Included in the Langstroth model modus operardic is the USDA Integrated Pest Management (IPM) program which includes the placing of pesticides classified as neurotoxins and developmental or reproductive toxins directly into the hive.

A growing concern is that the synergistic effect of combining pesticides in the hive with commonly used fungicides could be hundreds of times more toxic than any of the pesticides individually. These “medications,” as named by the beekeeping supply industry, must be applied in strict accordance with USDA and EPA warnings relative to length of treatment, method and volume of application, and specific time and temperature perimeters. These practices often conflict with the goal to maximize honey production. Compliance with most of the warnings would be difficult for the average chemist to manage, particularly when simultaneously treating for pests, diseases and fungi now common in the Langstroth hive. The design and utilization of the modern U.S. standard Langstroth hive model is contrary to any notion of sustainability or conservation of the bee and may be a factor contributing to the mysterious Colony Collapse Disorder (“CCD”) which is devastating the bee population.

By contrast, the KTBH facilitates small-scale, economical, “user-friendly” beekeeping for the backyard or rooftop hobbyist, gardener or anyone who understands and is concerned about our ecosystem, or the complex set of relationships among the living resources, habitats, and residents of an area. It includes plants, trees, animals, insects, fish, birds, micro-organisms, water, soil and people. Ecosystems vary greatly in size and the elements that make them up, but each is a functioning unit of nature. Everything that lives in an ecosystem is dependent on the other species and elements that are also part of that ecological community. If one part of an ecosystem is damaged, disrupted or disappears, there is an adverse impact on everything else.

When an ecosystem is healthy, scientists say it is sustainable meaning that all of the elements live in balance and are capable of reproducing themselves. There is usually biodiversity, such that there are a variety of living organisms and species in that environment. Our ecosystem and our food supply, which includes the honeybee in a very important way, has been and continues to be exploited by the great majority of beekeepers, educators, commercial honey producers and sellers of equipment and supplies, who have a vested interest in maintaining the status quo. This is vitally important because approximately one-third of everything in our diet relies upon the honeybee for pollination.

### SUMMARY OF THE INVENTION

The disclosed embodiments disclosed below further enhance the design and function of the KTBH and accelerate the movement towards natural, sustainable bee conservation and its favorable impact on our ecosystem. The disclosed embodiments incorporated into the top bar hive offer significant improvements to the conventional hives. The disclosed embodiments facilitate significant, sustainable, and improved hive operational and management “options” for the beekeeper and the bees. An objective of the disclosed hive configuration is to hand control of the hive and production back to the bees themselves and to minimize interference in their ecosystem for improved health of the bees and results.

The disclosed embodiments enable many possible hive configuration options, allowing it to be equally effectively when utilized by beekeepers with skill and experience levels ranging from beginner to master beekeeper. The disclosed hive may be configured as desired. Any option selected by the individual beekeeper over time will still protect the sustainability of the bee colony. Nothing is ever put into the hive that is known to be, or likely to be harmful either to the bees, to us, or to the wider environment, and nothing is taken out that the bees cannot afford to lose. Thus, the disclosed hive promotes sustainable beekeeping.

For example, a common design flaw of follower boards, or false backs, and queen excluders is the failure to provide functional barriers with integrity. Many hive designs do not take into account the movability and expansion or contraction of hive side walls. Side walls may warp, thereby leaving unacceptable gaps between the excluders, the follower boards and the side walls. The disclosed hive attaches small pieces of wood vertically to the sidewalls thereby creating raised channels for both the follower board and the excluder to stabilize them in place. In addition, the disclosed hive provides sufficient depth using this configuration to accommodate any concave or convex warping of the side walls.

This feature prevents the queen from passing through gaps caused by warping between the excluder and the side wall, and depositing eggs into comb reserved for honey. The raised channels also preserve the integrity of the follower board as a barrier for multiple purposes, including temperature control and hive splitting.

To preserve the very important natural pheromones, temperatures and bee security issues within the hives, processes were developed to physically access the hive interior without causing trauma, or at least less than when accessing the hive via removal of the top and top bars to inspect comb, to observe bee and predator activity, to add fondant or dry sugar in the winter, to inspect or remove the queen cage, to provide sugar syrup to the bees when necessary and the like. Every addition and modification that reduces the time that the hive is open, particularly via the top cover, also provides a measure of protection against robber bees, predators, viruses, fungus spores and the like.

To correct this flaw common to top bar hives, a side observation port with fixed glass is modified to attach a framed piece of glass to the hive with hinges to allow it to be opened giving access to the hive. The frame has a covering board attached using hinges. The covering board allows the hive interior to be kept dark, warmer and protects the glass. The feature allows the hive interior to be inspected for reasons requiring access to the hive interior. Thus, the disclosed embodiments provide access to the hive interior without removing the top and top bars of the hive.

The modification of the two identical observation/entrance ports on one side of the hive allows hive interior access without removing the lid and top bars solved many problems injurious to the health of the bees. It was still necessary, however, to open the hive via the top to feed sugar syrup to the bees. The disclosed hive resolves that issue with the addition of an entrance feeder being inserted into a slot through the end of the hive extending into the interior of the hive that dispenses syrup to the bees. The disclosed hive allows a user to determine with a simple look at the feeder bottle located outside of the hive whether or not additional syrup is needed.

The empty feeder bottle can be replaced by exchanging the empty jar with a full jar without disturbing the bees nor attracting robber bees. To keep the heavy bottle and feeder at an important right angle configuration to the hive, a support block is attached to the hive under the feeder apparatus. A cover for the end feeder port protects the hive against excessive ventilation, robber bees and the like when the feeder is not attached.

Other forms of sugar feeders are available for hives, but choices are limited for top bar hives, such as the one disclosed below. For example, top feeders, frames feeders and entrance feeders cannot be easily adapted for use in top bar hives. Further, few locations exist within the hive where a feeder may be located. Even if there is sufficient space within the hive, an inverted bottle feeder or baggie feeder only supply enough sugar syrup that demand replenishment every do or so. Obviously, attending to the interior feeder would result in additional openings of the hive with its associated risks.

Thus, the disclosed embodiments incorporate an entrance feeder, as disclosed above, that allows delivery of the sugar syrup without continually disrupting the behavioral pattern of the bees. Further, a quick visual check can tell the beekeeper that the syrup needs to be replenished.

Another feature of the disclosed embodiments is the incorporation of two identical bee entrances. This feature is enabled by the preceding features of the two identical and hive-symmetrical observation, or side ports, the exterior entrance feeder and the improvements regarding the follower and excluder boards. The entrances are configured such that there is one on each end. With both ends acting as entrances and the follower board in place, the disclosed hive may be divided into two independent, identical and complete units. When divided, the disclosed hive can be utilized as two nucleus hives for the purpose of developing a supply of new bees in order to start new hives, or splitting, or, alternatively, as two smaller perpetual hives in search of an exceptionally strong traditional colony or some combination of a nucleus and perpetual hive.

According to the disclosed embodiments, one end can be selected as the entrance with the corks removed from the entrance holes and without the follower board in place. By removing one cork from the opposite end, considered the hive back, the worker bees can enter a single entrance hole in order to develop honey comb located mostly in the rear of the hive without requiring them to enter the front entrance/brood end of the hive and travel over the brood comb to get to the honey comb end of the hive.

With identical structures on each end, the end selected to be the entrance for the primary configuration may be selected to facilitate positioning the hive to face any direction desired, such as southeast in the Mid-Atlantic area to face the morning sun. This feature is useful if the hive must be placed, due to location restrictions, against a fence, wall, shrubbery, or the like. The disclosed hive can still be placed with the side ports convenient to the beekeeper while opening the end most beneficial to the bees.

Thus, the disclosed embodiments seek to provide a natural, sustainable hive with state of the art enhancements that enable hive configuration options. The hive may be utilized by experienced beekeepers as well as novices. The disclosed hive is a complete, “turn-key,” hive with no other features required, no complex operating system necessary, no add-ons, no need for pesticides or other medications, no storage for parts or honey harvesting equipment, and nothing from glossy catalogs of the beekeeping product suppliers. The disclosed hive helps save bee populations and enhances the pollination of the beekeepers flowers and plants while providing a supply of honey.

Thus, a top bar hive configuration is disclosed. The top bar hive configuration includes a body having a front side and a hive end. The top bar hive configuration also includes a plurality of top bars extending across a top of the hive. The top bar hive configuration also includes at least one port located on the front side to allow access to an interior of the hive. The top bar hive configuration also includes at least one entrance hole in the hive end. The top bar hive configuration also includes a feeder port in the hive end to attach a feeder assembly. The top bar hive configuration also includes at least one pair of raised channels in the interior of the hive to secure an excluder or a follower board.

A top bar hive also is disclosed. The top bar hive includes a plurality of top bars extending across a top of the hive. Comb extends from at least one of the plurality of top bars into an interior of the hive. The top bar hive also includes a front side having two ports to access the comb inside the hive. Each of the two ports includes a glass plate and a port cover. The top bar hive also includes a center portion of the hive between the two ports to receive a partition within the interior of the hive.

Another top bar hive also is disclosed. The top bar hive includes a front side and a hive end. The top bar hive also includes a feeder assembly attachable to the hive end. The feeder assembly includes a feeder jar to mount on a feeder board. The top bar hive also includes a feeder port to receive the feeder assembly and to allow access to the feeder board within an interior of the hive.

### BRIEF DESCRIPTION OF THE DRAWING(S)

The accompanying figures are included to provide further understanding of the invention and constitute a part of the specification. The figures listed below illustrate embodiments of the invention and, together with the description, serve to explain the principles of the invention, as disclosed by the claims and their equivalents.

FIGS. 1A, 1B and 1C illustrate front side views of a hive according to the disclosed embodiments.

FIG. 2 illustrates an end view of the hive according to the disclosed embodiments.

FIG. 3 illustrates a perspective top and back side view of the hive according to the disclosed embodiments.

FIG. 4 illustrates an interior view of the hive with a queen excluder according to the disclosed embodiments.

FIG. 5 illustrates an interior view of the hive with a follower board according to the disclosed embodiments.

FIG. 6 depicts a feeder assembly for the hive according to the disclosed embodiments.

### DETAILED DESCRIPTION OF THE PREFERRED EMBODIMENTS

Aspects of the invention are disclosed in the accompanying description. Alternate embodiments of the present invention and the equivalents are devised without parting from the spirit or scope of the invention. It should be noted that like elements disclosed below are indicated by like reference numerals, where appropriate, in the figures.

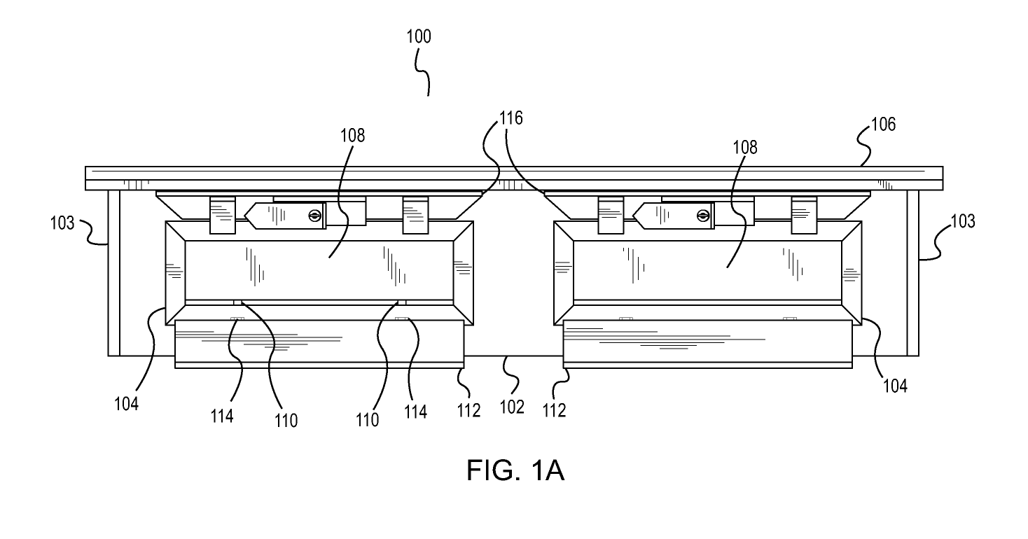

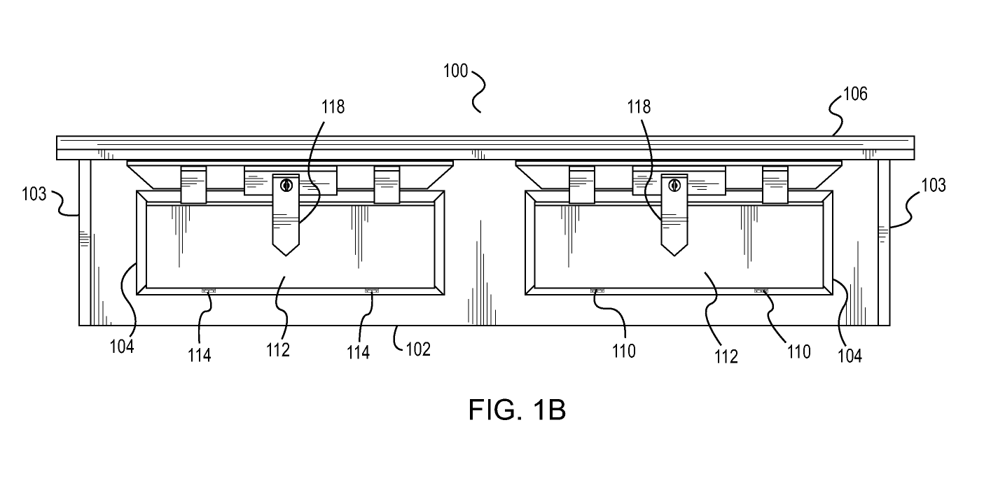

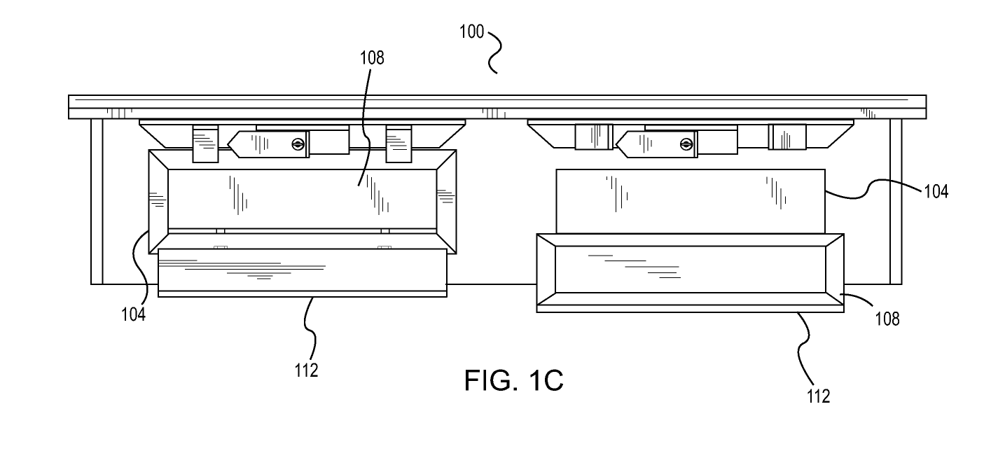

FIGS. 1A, 1B and 1C illustrate front side views of a hive 100 according to the disclosed embodiments. Hive 100 may be known as a top bar hive and is composed of wood, preferably, natural pine. Hive 100 includes a front side 102 and ends 103. The preferred dimensions of hive 100 are disclosed in greater detail below. Front side 102 includes side ports 104. As shown, two ports 104 are used to allow access into the hive interior without disrupting the honey comb by opening the top of hive 100.

Top cover 106 lies on top of the bars, disclosed below, that extend horizontally across the top of hive 100. Top cover 106 provides protection for the elements as well as stabilizes hive 100. Top cover 106 encloses the top bars that allow formation of the honey and brood comb. Top cover 106 may be removed to allow access to the bars.

Ports 104 provide additional features to promote the health and security of the beehive within hive 100. These features include glass plate 108 that is attached to front side 102 by hinges 110. Hinges 110 allow a plate 108 to be rotated away from the body of hive 100 with necessitating placing the plate on the ground or another surface, possibly scratching its surface as well. Plates 108 may be rotated towards the body of hive 100 to close ports 104.

Ports 104 also include port covers 112 that cover plates 108 to prevent breakage or scratching of the glass surfaces. Port covers 112 may enclose the area of front side 102 housing glass plates 108. Port covers 112 also may rotate away from the body of hive 100 using hinges 114. Alternatively, port cover 112 may be removed from hive 100 without the use of hinges.

Secure assemblies 116 are located above each port 104 and further secure the appropriate covers in place. Each assembly 116 may include a portion 118 that rotates axially to hold a port cover 112 in place and to make sure it does not slide or move during transport of hive 100.

FIG. 1B shows hive 100 with port covers 112 secured and portions 118 moved to hold the covers in place. FIG. 1A shows hive 100 with portions 118 rotate upwards and aligned horizontally with assemblies 116 so that port covers 112 are moved away from plates 108. Thus, a user may be able to see into the interior of hive 100.

FIG. 1C depicts another view of front side 102 according to the disclosed embodiments. In this view, glass plate 108 on one side of hive 100 covers the corresponding port 104. Port cover 112 for that port 104 is in the “open” configuration in that it is rotated away from the body of hive 100. On the opposite side, the corresponding glass plate 108 is configured away from port 104 along with the corresponding port cover 112. This configuration allows access to the interior of hive 100. Further, one port may serve for observation while another serves for access. A beekeeper may watch while another access hive 100 and provide instructions.

Any number of ports 104 may be includes in front side 102 of hive 100. Two ports are preferred due to size considerations and the ability to develop a separate beehive. Ports 104 also should be on one side of hive 100 for convenience but may be on opposite sides if desired, possibly offset from each other.

Thus, the disclosed hive includes two identical, symmetrical ports on one side, each with a dual function. Each port can be opened to allow a visual inspection of the hive interior through a glass viewing window for the purpose of determining the health and well-being of the bees and the state of their hive development efforts. This feature facilitates a relatively safe environment for the inspecting beekeeper, student or visitor although the wearing of safety clothing is advised since the bees will still be active outside the hive. Additionally if necessary, the glass viewing window can subsequently and easily be opened to allow entry into the hive body for such things as winter feeding of fondant, removal of an empty queen cage or other reasons one might find to enter the hive without removing the top and catastrophically disturbing the natural temperature and pheromones of the hive.

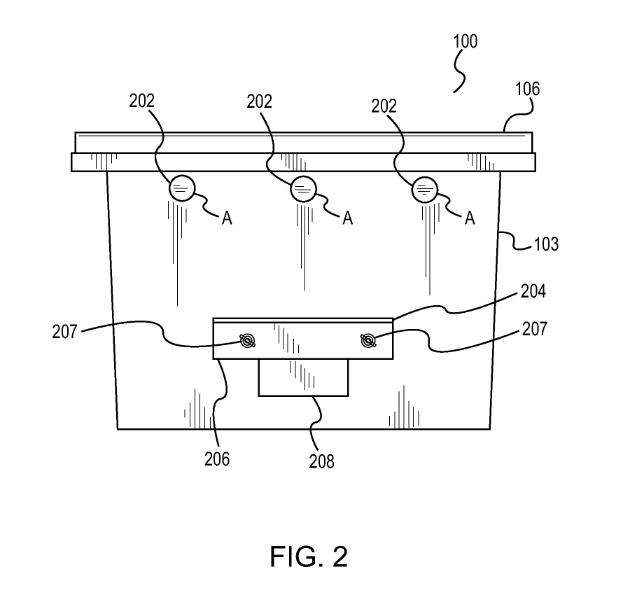

FIG. 2 depicts an end view of the hive according to the disclosed embodiments. As disclosed above, hive 100 includes hive ends 103. FIG. 2 shows a configuration of a hive end 103. Each hive end 103 may be identical, but configurable to be different according to the disclosed embodiments. Cover 106 may overlap a portion of hive end 103 to prevent openings for robber bees or other intruders from accessing the interior of hive 100.

Hive end 103 includes holes 202. Three holes are shown, but any number of holes may be configured. Preferably, holes 202 are aligned horizontally such that they are parallel to the bottom of hive 100. The preferred dimensions for holes 202 are disclosed below. Corks, or stoppers, A may be used to close a hole 202. Corks A fit snugly into holes 202. Thus, hive 100 may close or open entrances to the interior as desired.

Hive end 103 includes holes 202 for bee access and ventilation. Hive end 103 also includes a feeder port 204 to receive a feeder, disclosed in greater detail below. A feeder port cover 206 also is shown along with bolts 207 to secure the cover in place when the feeder is removed. FIG. 2 depicts feeder port cover 206 secured to prevent access to the interior of hive 100. Corks A within holes 202 may be removed as well to facilitate ventilation and bee entrances as appropriate. A support 208 is located below feeder port 204 so as to not interfere with the placement of port cover 206.

The disclosed hive includes two hive ends of identical design with each having three approximately 1″ holes for bee access and ventilation. Each end also has a 1-quart liquid feeder capability located and filled from outside the hive delivering nutrition directly into the hive body. This feature eliminates the need to open the hive for supplemental feeding and thereby maintains the integrity of the very important natural hive interior pheromones plus the temperature in all weather conditions. If the beekeeper chooses not to use one or both of the feeders, the feeder ports have covers to protect the hive interior from bee-inclement weather, robber bees and other pests.

Because both ends can be configured as entrances, the pure honey comb end can be opened by removing one or more corks which will allow the worker bees to develop the honey comb without requiring them to enter the brood end and travel over the brood comb while engorged with nectar to get to the honey comb end. With identical entrances on each end, the entrance end can be chosen that allows the beekeeper to position the hive facing any direction desired (southeast towards the morning sun preferred in the Mid-Atlantic area). This is particularly useful if the hive must be placed, due to restricted location options, against a fence, wall, shrubbery or whatever. It can still be placed with the side ports convenient to the beekeeper while opening the end most beneficial to the bees. If there was only one entrance and the beekeeper had limited space/locations for the hive (again, backyard next to a storage building, fence, etc.), and wished to have the entrance facing the preferred southeast, they may find it necessary to forgo facing it southeast or forgo use of the side ports.

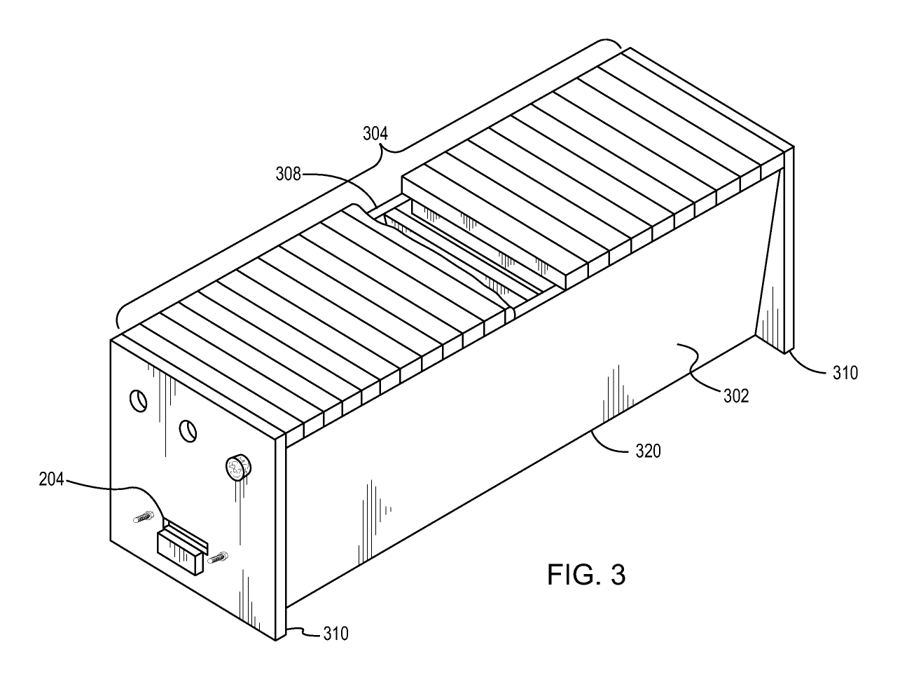

FIG. 3 depicts hive 100 from a top view with top cover 106 removed. This view shows the inside of the hive structure with the slanted sides to promote honey comb formation on top bars 304. As shown, top bars 304 may be placed along the top of hive 100 with a length of 15 inches to rest on the sides of the hive. Top bars 304 may have a 1½ inch or 1¼ inch width. Top bars 304 are separately removable so that a beekeeper may take one out at a time without catastrophically disrupting the rest of the hive.

FIG. 3 depicts the top bars in place on the disclosed hive structure. When in place, top bars 304 should provide a substantially level upper surface creating a barrier between the hive structure and top cover 106. FIG. 3 also shows a central portion 308 where one or more top bars 304 are removed, or, cut away.

FIG. 3 also shows a back side 302 of hive 100. Back side 302 does not include ports or holes, and, as shown, slants toward a bottom portion 320 of hive 100. Preferably, bottom portion 320 is smaller in width that the top of hive 100. Portions 310 may extend away from back side 302 to provide stability to hive 100 so that the hive does not rock back and forth. FIG. 3 also shows feeder port 204 in an “open” configuration, but without the feeder attached.

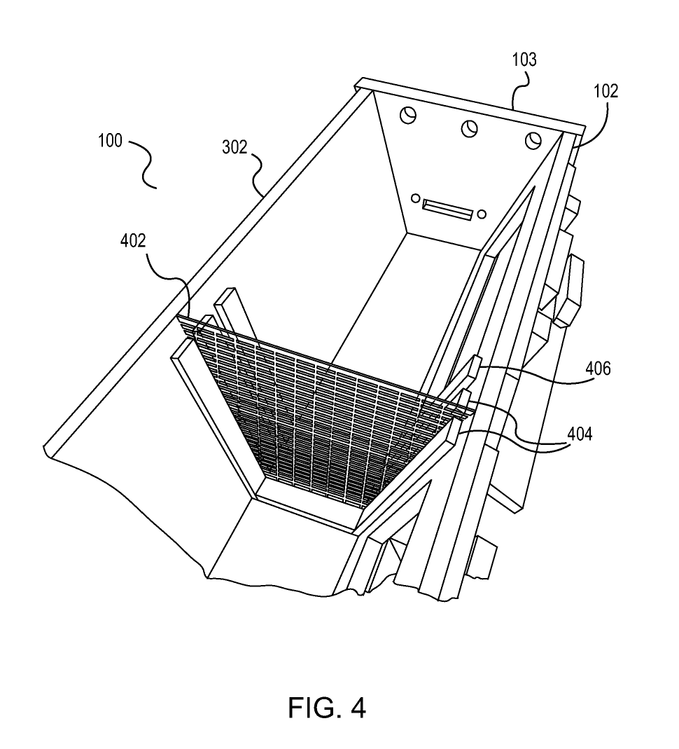

FIG. 4 depicts an interior view of hive 100 with a queen excluder 402 according to the disclosed embodiments. Queen excluder 402 may be inserted in the approximate middle length-wise of hive 100. Queen excluder 402 includes material or screening shaped exactly like the hive interior touching both sides. The sides of queen excluder 402 can be inserted into two ¼″ deep raised channels, one on each side in the middle of the hive. The channels are formed by slats 404, and have a width to accommodate excluder 402. Slat 406 may be used in conjunction with one of the slats 404 to create a channel for the follower board, disclosed below.

This feature prevents the queen, due to her size, from moving past the center of the hive thereby guaranteeing the development of pure honey comb in the end from which she is excluded and eliminating the mixing of brood comb with honey comb. Smaller bees may move into this side. Thus, excluder 402 includes a plurality of holes or apertures sized to provide these functions. Further, with excluder 402 held in place by raised channels, any warping of the sides over an extended period will not leave a gap between the side-edge of the excluder and the side of the hive thereby maintaining the reliability of the excluder.

FIG. 4 also shows the interior view of hive end 103 with holes 202 and feeder port 204 closed.

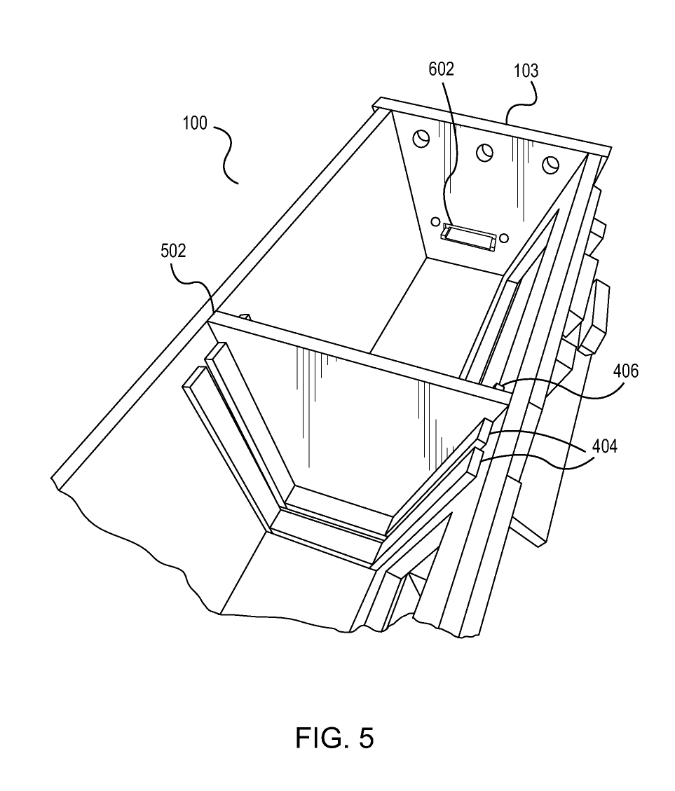

FIG. 5 depicts an interior view of hive 100 with a follower board 502 according to the disclosed embodiments. Removable follower board 502 (also known as a false end) typically inserted to configure or reduce the interior hive space for winter temperature control takes on other important functions when used in conjunction with the complete entrance capability on both ends. With both ends open as entrances, it can be used to divide a 48″ hive into two 24″ nucleus (nuc) hives each with a queen, workers and drones for the purpose of developing a supply of new bees to start new hives, (aka “splitting”) or into two 24″ perpetual hives in search of an exceptionally strong traditional colony or a combination of a nucleus and a perpetual hive.

Follower board 502 also may be inserted into raised channels, much like excluder 402. As shown, however, follower board 502 is not inserted into the same raised channel as excluder 402. This difference may be due to the thickness of follower board 502, which may be greater than the thickness or width of excluder 402. Follower board 502 also is constructed to fit within the interior of hive 100 to provide snug but not tight fit. This allows the material of follower board 502 and hive 100 to expand and contract without causing stress to induce cracks or passages between sections of hive 100.

Slats 406 may serve to form the raised channels to receive follower board 502. Thus, one of slats 404 on each side may be used to form raised channels for excluder 402 and follower board 502. As shown, the false end is placed in the raised channels. Alternatively, one set of raised channels may be used by hive 100 for excluder 402 and follower board 502. The false end also may include a top bar to stabilize its position when placed between other top bars 304. Feeder board 602 also is shown and is disclosed in greater detail below.

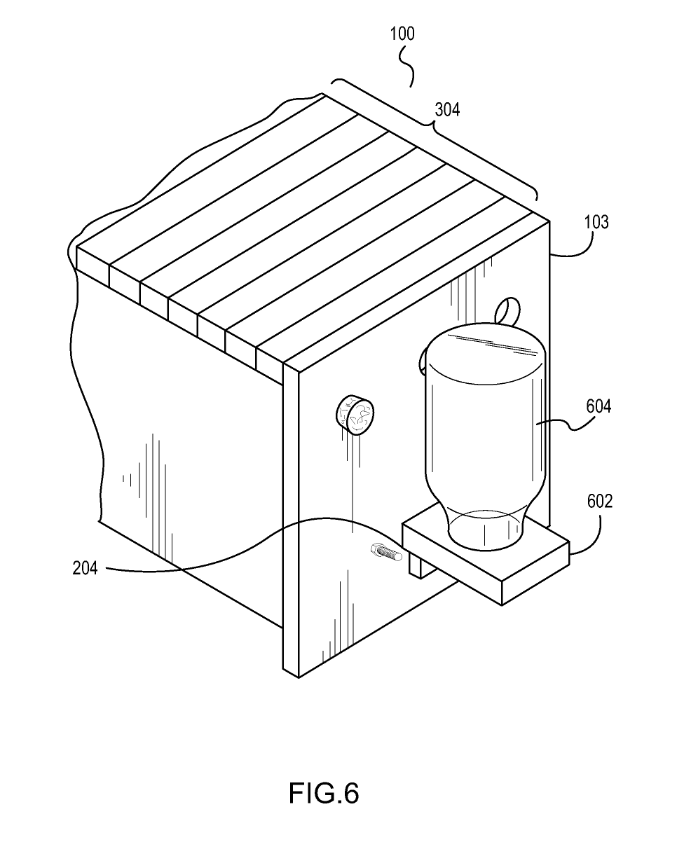

FIG. 6 depicts a feeder assembly for hive 100 according to the disclosed embodiments. The feeder assembly comprises feeder board 602 and feeder jar 604. Other components may be included to promote the delivery of sugar syrup or other foods stored within feeder jar 604 to the bees, as well as stabilize the feeder assembly. Feeder board 602 is inserted through feeder port 204 so that a portion of the board is positioned within the interior of hive 100, as shown in FIG. 5. This feature allows the bees to access the contents of feeder jar 604 without leaving hive 100.

Feeder jar 604 is secured into feeder board 602 by positioning the perforated “top” of the jar into a hole configured to receive the top. Feeder board 602 preferably is parallel to the ground. Feeder jar 604 preferably is positioned at about a right angle to feeder board 602 so that the syrup or feed flows downwards as the jar is emptied. Alternatively, feeder board 602 may position feeder jar 604 at an angle. Replacement of feeder jar 604 may be accomplished by removing it from feeder board 602 and putting a full jar in its place. The interior of hive 100 does not need to be accessed or disturbed during this process.

Should a beekeeper want to introduce medicine and the like to the bees, then this additive may be placed with the syrup in feeder jar 604 and distributed accordingly. The top or side accesses to hive 100 do not need to be used. Further, the interior of the hive itself is not disturbed, such as placing the medicine inside hive 100.

Preferably, feeder jar 604 is a glass or plastic jar that allows the beekeeper to visually determine the amount of syrup left in the feeding assembly. Feeder board 602 may be comprised of Cyprus wood in order to give it the strength to support feeder jar 604 and its contents. The Cyprus wood also does not expand or absorb the liquids from the feeder jar that would lead to its deterioration.

The feeding assembly shown in FIG. 6 may be located on both ends of hive 100. Thus, each hive end 103 may have the ports and components necessary to feed the bees. If only one hive end 103 is used for feeding, then the opposite hive end 103 may be configured as shown in FIG. 2. Depending on which hive end 103 is appropriate, the feeder assembly may be attached in a variety of configurations to fit most scenarios.

The disclosed hive structure may be mounted on concrete blocks, wooden crates, or other functionally-similar stackable units. The stacking units can be stacked relatively level at a height comfortable to the beekeeper, and shimmed-out to make the hive level, both side to side and back to back, between the bottom of the hive and top of the stacking units with any material that will not deteriorate. Wooden legs bolted to the hive body may create problems in installation, with deterioration and present unnecessary challenges in leveling. However, legs of any suitable material may be used to hold the disclosed hive structure. Moreover, the disclosed hive structure may be placed on a table or ground if conditions (pests, moisture, and vegetation) allow. It also may be suspended above ground if desired for the protection of children and others, dogs and other pets or to protect it from dogs, raccoons, skunks, mice, ants and the like.

The disclosed hive structure may measure 4 feet long by 12 inches high by 15 inches wide. It may include approximately 30 top bars, with accommodations for additional top bars depending on how the beekeeper chooses to configure it. The hive structure also may include 4 extra bars, 8 corks and 2 feeders (without the standard quart glass jar unless picked-up), 1 follow board, and 1 queen excluder. Additional materials may be included, as disclosed below.

The hive body may be constructed from natural pine with the exterior joined with wood screws especially manufactured for use with pine to retard any rust or corrosion. The top bars and sliding false movable end also may be constructed of pine. The queen excluder is made of plastic. The two observation ports are exterior-attached with stainless steel hinges and screws.

The top cover may act as a lid to protect the hive structure from the elements. The top cover may be constructed with plywood, pine, and acrylic flashing. It rests on the top bars with the top bars acting as a barrier between the top cover and the hive interior/bee space. The top bars are shown in greater detail below.

The exterior of the disclosed hive structure may be treated with a hand-rubbed protective finish of a combination of two ingredients, raw flax seed oil and bees wax. The finish may be applied “crock-pot” warm. Because it has no drying petroleum agents or solvents found in most commercial finishes, the finish may soak into the wood naturally feeling dry to the touch, developing a warm/golden patina over time. Alternatively, any finish that is safe for children's furniture, wooden eating utensils/bowls, and the like may be used on the disclosed hive structure.

Thus, the disclosed hive structure provides novel and nonobvious advantages over conventional hives in promoting sustainable beekeeping. Further, the disclosed hive structure allows anyone to harvest honey and wax to consume, use or sell, experience a more bountiful flower and vegetable garden, or experience a unique and immensely rewarding hobby. The disclosed hive structure also allows one to witness the miracle of the bee's social order and lives and learn how they communicate through pheromones and dances. The structure allows one to, with relative safety, observe the bees through the two side-glass ports bearing in mind that the bees still may be exiting and entering the end holes. One may touch the glass on a cold day and feel the life-saving warmth the bees are generating.

The harvest of the honey and honey comb may allow one to obtain homeopathic relief from allergies. Honey also has the necessary components similar to a slow-release hydrogen peroxide. This makes honey an ideal substance to use in the treatment of infected wounds, other bacterial disorders and burns. The disclosed hive structure promotes the use of the honey and bees to provide these remedies.

Due to smaller colony size, simplicity and lower costs, one may more readily establish a new colony in a backyard or rooftop. The disclosed hive structure also avoids the need for lifting heavy honey box sections called supers (supers can weigh 60 pounds or more when full of honey) or other hive sections for inspections and rotations, pesticide/IPM treatments, frame manipulations, and the like, as necessary with the Langstroth hive. Further, one may harvest as little as one top bar of honey at a time for toast or a bit more if gifting to friends or neighbors.

The disclosed hive structure also enables one to extract two or three bars of brood comb (already in the process of natural size retrogression) with bees attached along with two or three bars of honey, insert them into an empty hive and start a new colony without the need to purchase “industrial”, genetically engineered, hybrid bees and queens. This is known as “splitting” a hive. In the new hive, worker bees will develop a new-natural, smaller sized queen. This procedure will accelerate the desirable effect of “retrogressing” the species back to their normal size and related activities such as beneficial smaller cell sizes. The small or natural cell sizes may inhibit the infestation of the verroa mite. The extracted brood comb or honey comb may be placed into another hive structure to start the new colony without disrupting the old colony or requiring extensive retrofits or changes to the hive structures.

The disclosed hive structure may eliminate the need for space to store supers and protect them from wax moths. In the Langstroth hive, boxes with frames and old wax from which the honey has been extracted plus other commercial hive management paraphernalia must be stored safe from infestation until the next season. The disclosed hive structure is “turn-key”, a complete beekeeping unit including a natural hand-rubbed exterior finish of heated bees wax and raw flax seed oil. The disclosed hive structure also may eliminate the need for a centrifugal extractor (Langstroth Beginning Extractor Kit=$500+), to harvest the honey plus the space to safely store and operate this and other Langstroth-exclusive equipment.

It will be apparent to those skilled in the art that various modifications and variations can be made in the disclosed hive configuration without departing from the spirit or scope of the invention. Thus, it is intended that the present invention cover these modifications and variations of the embodiments disclosed above provided that they come within the scope of any claims or their equivalents.

1. A top bar hive configuration comprising:
a body having a front side and a hive end;
a plurality of top bars extending across a top of the hive;
at least one port located on the front side to allow access to an interior of the hive;
at least one entrance hole in the hive end;
a feeder port in the hive end to attach a feeder assembly; and
at least one pair of raised channels in the interior of the hive to secure an excluder or a follower board.

2. The top bar hive configuration of claim 1, further comprising a top cover to cover the plurality of top bars.

3. The top bar hive configuration of claim 1, further comprising a glass plate to cover the at least one port, wherein the glass plate is rotatable away from the front side.

4. The top bar hive configuration of claim 3, further comprising a port cover to cover the glass plate.

5. The top bar hive configuration of claim 1, further comprising a port cover to cover the at least one port.

6. The top bar hive configuration of claim 1, wherein the feeder assembly includes a feeder jar.

7. The top bar hive configuration of claim 1, wherein the feeder assembly includes a feeder plate inserted through the feeder port.

8. The top bar hive configuration of claim 1, further comprising another pair of raised channels.

9. A top bar hive comprising:
a plurality of top bars extending across a top of the hive, wherein comb extends from at least one of the plurality of top bars into an interior of the hive;
a front side having two ports to access the comb inside the hive, wherein each of the two ports include a glass plate and a port cover; and
a center portion of the hive between the two ports to receive a partition within the interior of the hive.

10. The top bar hive of claim 9, further comprising a hive end having entrance holes for the interior of the hive.

11. The top bar hive of claim 9, wherein the glass plate is attached to the front side with hinges such that the glass plate is rotatable.

12. The top bar hive of claim 9, wherein the port cover is attached to the front side with hinges such that the port cover is rotatable.

13. The top bar hive of claim 9, wherein the partition includes a queen excluder.

14. The top bar hive of claim 9, wherein the partition includes a follower board.

15. The top bar hive of claim 9, wherein the port cover is configured to cover the glass plate and the port.

16. A top bar hive comprising:
a front side and a hive end;
a feeder assembly attachable to the hive end, wherein the feeder assembly includes a feeder jar to mount on a feeder board; and
a feeder port to receive the feeder assembly and to allow access to the feeder board within an interior of the hive.

17. The top bar hive of claim 16, further comprising a feeder port cover to enclose the feeder port when the feeder assembly is not attached to the hive end.

18. The top bar hive of claim 16, wherein the feeder jar is removable from the feeder board.

19. The top bar hive of claim 16, further comprising entrance holes within the hive end.

20. The top bar hive of claim 16, further comprising another hive end having another feeder port to accommodate another feeding assembly.
